(19) United States
(12) Patent Application Publication
(10) Pub. No.: US 2025/0102826 A1
(43) Pub. Date: Mar. 27, 2025

(54) TEMPLE AND EAR HORN ASSEMBLY FOR HEADWORN COMPUTER

(71) Applicant: Mentor Acquisition One, LLC, Plantation, FL (US)

(72) Inventors: Ralph F. OSTERHOUT, San Francisco, CA (US); Greg HIRES, San Francisco, CA (US); Nima L. SHAMS, San Jose, CA (US); John D. HADDICK, Mill Valley, CA (US); Joseph Rejhon DUGGAN, Berkeley, CA (US); Patrick John William CASEY, San Francisco, CA (US); Nicholas POLINKO, San Francisco, CA (US)

(21) Appl. No.: 18/972,640

(22) Filed: Dec. 6, 2024

Related U.S. Application Data
(63) Continuation of application No. 18/477,350, filed on Sep. 28, 2023, now Pat. No. 12,197,043.
Application No. 18/477,350 is a continuation of application No. 18/048,829, filed on Oct. 21, 2022, now Pat. No. 11,809,022.
Application No. 18/048,829 is a continuation of application No. 16/942,726, filed on Jul. 29, 2020, now Pat. No. 11,506,912.
Application No. 16/942,726 is a continuation of application No. 15/859,828, filed on Jan. 2, 2018, now Pat. No. 10,732,434.
Application No. 15/859,828 is a continuation of application No. 14/820,253, filed on Aug. 6, 2015, now Pat. No. 9,897,822.
Application No. 14/820,253 is a continuation of application No. 14/262,615, filed on Apr. 25, 2014, now Pat. No. 9,158,116.

(51) Int. Cl. G02C 5/14; G02B 27/01; G02C 5/20; G02C 11/00

(52) U.S. Cl. CPC G02C 5/143; G02B 27/017; G02B 27/0176; G02C 5/20; G02C 11/10; G02B 2027/0178

(57) ABSTRACT

Aspects of the present invention relate to a head-worn computer having a see-through computer display, a frame mechanically adapted to hold the see-through computer, a first side arm pivotally attached to the frame and adapted to hold the head-worn computer in place on a head of the user, wherein the first side arm comprises a temple section and an ear horn section and the temple section further comprising a compartment adapted to contain a battery, wherein the battery powers the see-through computer display.

### CROSS-REFERENCE TO RELATED APPLICATIONS

This application is a continuation of U.S. Non-Provisional application Ser. No. 18/477,350, filed Sep. 28, 2023, which is a continuation of U.S. Non-Provisional application Ser. No. 18/048,829, filed Oct. 21, 2022, (now U.S. Pat. No. 11,809,022, issued on Nov. 7, 2023), which is a continuation of U.S. Non-Provisional application Ser. No. 16/942,726, entitled “TEMPLE AND EAR HORN ASSEMBLY FOR HEADWORN COMPUTER,” filed Jul. 29, 2020, (now U.S. Pat. No. 11,506,912, issued on Nov. 22, 2022), which is a continuation of U.S. Non-Provisional application Ser. No. 15/859,828, entitled “TEMPLE AND EAR HORN ASSEMBLY FOR HEADWORN COMPUTER”, filed Jan. 2, 2018 (now U.S. Pat. No. 10,732,434, issued on Aug. 4, 2020), which is a continuation of U.S. Non-Provisional application Ser. No. 14/820,253, entitled “TEMPLE AND EAR HORN ASSEMBLY FOR HEADWORN COMPUTER”, filed Aug. 6, 2015 (now U.S. Pat. No. 9,897,822, issued on Feb. 20, 2018), which is a continuation of U.S. Non-Provisional application Ser. No. 14/262,615, entitled “TEMPLE AND EAR HORN ASSEMBLY FOR HEADWORN COMPUTER”, filed Apr. 25, 2014 (now U.S. Pat. No. 9,158,116, issued on Oct. 13, 2015). The above-identified applications are incorporated herein by reference in their entirety.

### BACKGROUND

### Field of the Invention

This invention relates to head worn computing. More particularly, this invention relates to temple and ear horn assemblies for head worn computers.

### Description of Related Art

Wearable computing systems have been developed and are beginning to be commercialized. Many problems persist in the wearable computing field that need to be resolved to make them meet the demands of the market.

### SUMMARY

Aspects of the present invention relate to temple and ear horn assemblies for head worn computers.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

Embodiments are described with reference to the following Figures. The same numbers may be used throughout to reference like features and components that are shown in the Figures:

FIG. 1 illustrates a head worn computing system in accordance with the principles of the present invention.

FIG. 2 illustrates a head worn computing system with optical system in accordance with the principles of the present invention.

FIGS. 3A, 3B, and 3C illustrate three views of a head worn computer in accordance with the principles of the present invention.

FIGS. 4A and 4B illustrate a temple and ear horn in accordance with the principles of the present invention.

FIGS. 5A, 5B, 5C, 5D, 5E, and 5F illustrate a temple and ear horn assembly in various states in accordance with the principles of the present invention.

FIG. 6 illustrates an adjustable nose bridge assembly in accordance with the principles of the present invention.

FIG. 7 illustrates an adjustable nose bridge assembly in accordance with the principles of the present invention.

While the invention has been described in connection with certain preferred embodiments, other embodiments would be understood by one of ordinary skill in the art and are encompassed herein.

### DETAILED DESCRIPTION

Aspects of the present invention relate to head-worn computing (“HWC”) systems. HWC involves, in some instances, a system that mimics the appearance of head-worn glasses or sunglasses. The glasses may be a fully developed computing platform, such as including computer displays presented in each of the lenses of the glasses to the eyes of the user. In embodiments, the lenses and displays may be configured to allow a person wearing the glasses to see the environment through the lenses while also seeing, simultaneously, digital imagery, which forms an overlaid image that is perceived by the person as a digitally augmented image of the environment, or augmented reality (“AR”).

HWC involves more than just placing a computing system on a person's head. The system may need to be designed as a lightweight, compact and fully functional computer display, such as wherein the computer display includes a high resolution digital display that provides a high level of emersion comprised of the displayed digital content and the see-through view of the environmental surroundings. User interfaces and control systems suited to the HWC device may be required that are unlike those used for a more conventional computer such as a laptop. For the HWC and associated systems to be most effective, the glasses may be equipped with sensors to determine environmental conditions, geographic location, relative positioning to other points of interest, objects identified by imaging and movement by the user or other users in a connected group, and the like. The HWC may then change the mode of operation to match the conditions, location, positioning, movements, and the like, in a method generally referred to as a contextually aware HWC. The glasses also may need to be connected, wirelessly or otherwise, to other systems either locally or through a network. Controlling the glasses may be achieved through the use of an external device, automatically through contextually gathered information, through user gestures captured by the glasses sensors, and the like. Each technique may be further refined depending on the software application being used in the glasses. The glasses may further be used to control or coordinate with external devices that are associated with the glasses.

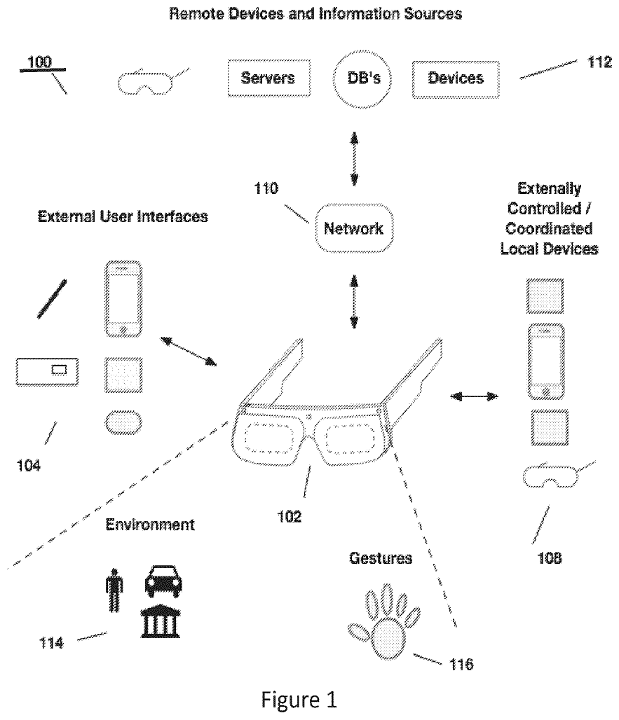

Referring to FIG. 1, an overview of the HWC system 100 is presented. As shown, the HWC system 100 comprises a HWC 102, which in this instance is configured as glasses to be worn on the head with sensors such that the HWC 102 is aware of the objects and conditions in the environment 114. In this instance, the HWC 102 also receives and interprets control inputs such as gestures and movements 116 of a body part of a user. The HWC 102 may communicate with external user interfaces 104. The external user interfaces 104 may provide a physical user interface to take control instructions from a user of the HWC 102 and the external user interfaces 104 and the HWC 102 may communicate bi-directionally to affect the user's command and provide feedback to the external device 108. The HWC 102 may also communicate bi-directionally with externally controlled or coordinated local devices 108. For example, an external user interface 104 may be used in connection with the HWC 102 to control an externally controlled or coordinated local device 108. The externally controlled or coordinated local device 108 may provide feedback to the HWC 102 and a customized GUI may be presented in the HWC 102 based on the type of device or specifically identified device 108. The HWC 102 may also interact with remote devices and information sources 112 through a network connection 110. Again, the external user interface 104 may be used in connection with the HWC 102 to control or otherwise interact with any of the remote devices 108 and information sources 112 in a similar way as when the external user interfaces 104 are used to control or otherwise interact with the externally controlled or coordinated local devices 108. Similarly, HWC 102 may interpret gestures 116 (e.g. captured from forward, downward, upward, rearward facing sensors such as camera(s), range finders, IR sensors, etc.) or environmental conditions sensed in the environment 114 to control either local or remote devices 108 or 112.

We will now describe each of the main elements depicted on FIG. 1 in more detail; however, these descriptions are intended to provide general guidance and should not be construed as limiting. Additional description of each element may also be further described herein.

The HWC 102 is a computing platform intended to be worn on a person's head. The HWC 102 may take many different forms to fit many different functional requirements. In some situations, the HWC 102 will be designed in the form of conventional glasses. The glasses may or may not have active computer graphics displays. In situations where the HWC 102 has integrated computer displays the displays may be configured as see-through displays such that the digital imagery can be overlaid with respect to the user's view of the environment 114. There are a number of see-through optical designs that may be used, including ones that have a reflective display (e.g. LCOS, DLP), emissive displays (e.g. OLED, LED), hologram, TIR waveguides, and the like. In embodiments, lighting systems used in connection with the display optics may be solid state lighting systems, such as LED, OLED, quantum dot, quantum dot LED, etc. In addition, the optical configuration may be monocular or binocular. It may also include vision corrective optical components. In embodiments, the optics may be packaged as contact lenses. In other embodiments, the HWC 102 may be in the form of a helmet with a see-through shield, sunglasses, safety glasses, goggles, a mask, fire helmet with see-through shield, police helmet with see through shield, military helmet with see-through shield, utility form customized to a certain work task (e.g. inventory control, logistics, repair, maintenance, etc.), and the like.

The HWC 102 may also have a number of integrated computing facilities, such as an integrated processor, integrated power management, communication structures (e.g. cell net, WiFi, Bluetooth, local area connections, mesh connections, remote connections (e.g. client server, etc.)), and the like. The HWC 102 may also have a number of positional awareness sensors, such as GPS, electronic compass, altimeter, tilt sensor, IMU, and the like. It may also have other sensors such as a camera, rangefinder, hyper-spectral camera, Geiger counter, microphone, spectral illumination detector, temperature sensor, chemical sensor, biologic sensor, moisture sensor, ultrasonic sensor, and the like.

The HWC 102 may also have integrated control technologies. The integrated control technologies may be contextual based control, passive control, active control, user control, and the like. For example, the HWC 102 may have an integrated sensor (e.g. camera) that captures user hand or body gestures 116 such that the integrated processing system can interpret the gestures and generate control commands for the HWC 102. In another example, the HWC 102 may have sensors that detect movement (e.g. a nod, head shake, and the like) including accelerometers, gyros and other inertial measurements, where the integrated processor may interpret the movement and generate a control command in response. The HWC 102 may also automatically control itself based on measured or perceived environmental conditions. For example, if it is bright in the environment the HWC 102 may increase the brightness or contrast of the displayed image. In embodiments, the integrated control technologies may be mounted on the HWC 102 such that a user can interact with it directly. For example, the HWC 102 may have a button(s), touch capacitive interface, and the like.

As described herein, the HWC 102 may be in communication with external user interfaces 104. The external user interfaces may come in many different forms. For example, a cell phone screen may be adapted to take user input for control of an aspect of the HWC 102. The external user interface may be a dedicated UI, such as a keyboard, touch surface, button(s), joy stick, and the like. In embodiments, the external controller may be integrated into another device such as a ring, watch, bike, car, and the like. In each case, the external user interface 104 may include sensors (e.g. IMU, accelerometers, compass, altimeter, and the like) to provide additional input for controlling the HWD 104.

As described herein, the HWC 102 may control or coordinate with other local devices 108. The external devices 108 may be an audio device, visual device, vehicle, cell phone, computer, and the like. For instance, the local external device 108 may be another HWC 102, where information may then be exchanged between the separate HWCs 108.

Similar to the way the HWC 102 may control or coordinate with local devices 106, the HWC 102 may control or coordinate with remote devices 112, such as the HWC 102 communicating with the remote devices 112 through a network 110. Again, the form of the remote device 112 may have many forms. Included in these forms is another HWC 102. For example, each HWC 102 may communicate its GPS position such that all the HWCs 102 know where all of HWC 102 are located.

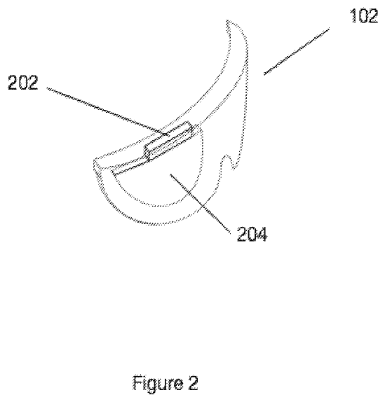

FIG. 2 illustrates a HWC 102 with an optical system that includes an upper optical module 202 and a lower optical module 204. While the upper and lower optical modules 202 and 204 will generally be described as separate modules, it should be understood that this is illustrative only and the present invention includes other physical configurations, such as that when the two modules are combined into a single module or where the elements making up the two modules are configured into more than two modules. In embodiments, the upper module 202 includes a computer controlled display (e.g. LCOS, DLP, OLED, etc.) and image light delivery optics. In embodiments, the lower module includes eye delivery optics that are configured to receive the upper module's image light and deliver the image light to the eye of a wearer of the HWC. In FIG. 2, it should be noted that while the upper and lower optical modules 202 and 204 are illustrated in one side of the HWC such that image light can be delivered to one eye of the wearer, that it is envisioned by the present invention that embodiments will contain two image light delivery systems, one for each eye. It should also be noted that while many embodiments refer to the optical modules as “upper” and “lower” it should be understood that this convention is being used to make it easier for the reader and that the modules are not necessarily located in an upper-lower relationship. For example, the image generation module may be located above the eye delivery optics, below the eye delivery optics, on a side of the eye delivery optics, or otherwise positioned to satisfy the needs of the situation and/or the HWC 102 mechanical and optical requirements.

An aspect of the present invention relates to the mechanical and electrical construction of a side arm of a head worn computer. In general, when a head worn computer takes the form of glasses, sun-glasses, certain goggles, or other such forms, two side arms are included for mounting and securing the had worn computer on the cars of a person wearing the head worn computer. In embodiments, the side arms may also contain electronics, batteries, wires, antennas, computer processors, computer boards, etc. In embodiments, the side arm may include two or more sub-assemblies. For example, as will be discussed in more detail below, the side arm may include a temple section and an car horn section.

The two sections may, for example, be mechanically arranged to allow an car horn section to move such that both side arms can fold into a closed position.

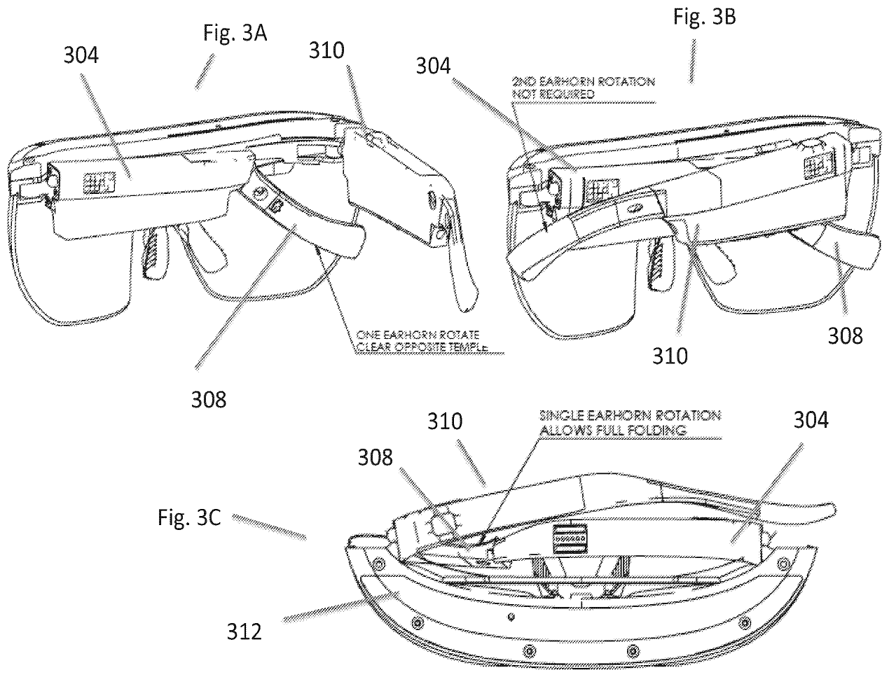

FIGS. 3A, 3B, and 3C illustrate three separate views 102A, 102B and 102C of a head worn computer 102 according to the principles of the present invention. Turning to the head worn computer illustrated as 102A in FIG. 3A, one side arm of the HWC 102 is folded into its closed position. The car horn section 308 of the side arm is rotated relative to its temple section 304 to create space relative to the other side arm 310 so when the other side arm is moved into its closed position it can fully close. In a situation where the car horn did not rotate to create the space (not illustrated) the car horn would physically interfere with the other side arm 310, when the side arm was in the closed position, and prevent the other side arm 310 from fully closing. The HWC 102B view in FIG. 3B illustrates the HWC 102B with both side arms folded into a fully closed position. Note that the car horn 308 is in the rotated position with respect to its temple section 304 such that the other arm 310 closed without interfering with the car horn 308. The HWC 102C view in FIG. 3C also illustrates both arms in closed positions with the car horn 308 rotated to create the space for the other arm 310 to fully close. FIG. 3C also illustrates a portion of the HWC 102 where electronics may be housed in a top mount 312. The top mount may contain electronics, sensors, optics, processors, memory, radios, antennas, etc.

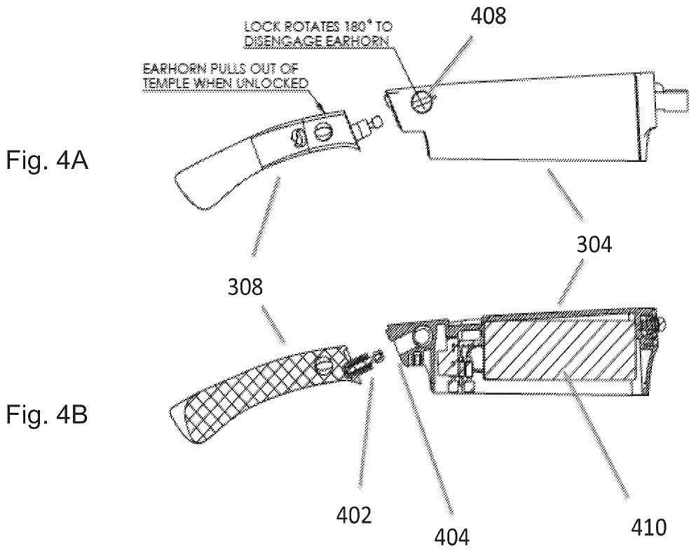

FIG. 4A and FIG. 4B illustrate a side arm configuration in accordance with the principles of the present invention. In this embodiment, the side arm includes two sub-assemblies: the temple section 304 and the car horn 308. FIG. 4A and FIG. 4B illustrate two views of the side arm assembly, one from an outer perspective in FIG. 4A and one from a sectioned perspective in FIG. 4B. The car horn includes a pin 402 that is designed to fit into a hole 404 and to be secured by connector 408. The connector 408 is rotatable and in one position locks the pin 402 in place and in another position unsecures the pin 402 such that the car horn 308 can be removed and re-attached to the temple section 304. This allows the detachment and re-attachment of the car horn 308 from the temple section 304. This also allows for the sale of different car horns 308 for replacement, of which a variety of colors and patterns may be offered. In embodiments, the temple section 304 may include a battery compartment 410 and other electronics, wires, sensors, processors, etc.

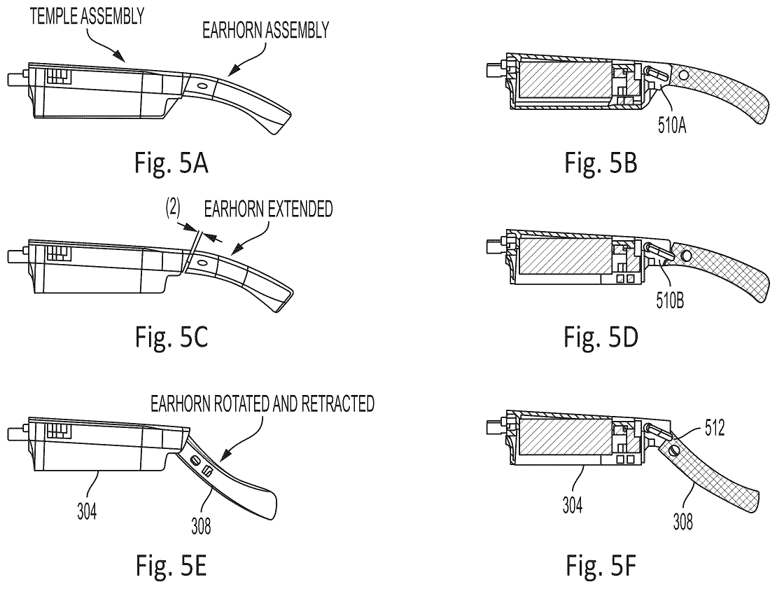

FIG. 5A, FIG. 5B, FIG. 5C, FIG. 5D, FIG. 5E, and FIG. 5F illustrate several views of a HWC side arm with temple 304 and car horn 308 sections. The views include outer perspectives and cross sections as well as various states of the security of the car horn 308 with the temple section 304. FIGS. 5C and 5D illustrates the car horn 308 and the temple section 304 in a secure un-rotated position. The same pin 402 and connector 408 system described in connection with FIG. 4A and FIG. 4B is illustrated in the cross sections of FIG. 5B, FIG. 5D, and FIG. 5F. In the secured un-rotated position the pin is pulled internally within the temple section firmly such that it stays in place. FIG. 5C and FIG. 5D illustrates a state where the car horn 308 is separated from the temple section 304. This state is achieved when pressure is used to pull on the car horn 308. In embodiments, the pressure is exerted by a user pulling on the car horn 308, which compresses a spring 510B that is mechanically associated with the pin 402 in the car horn 308. The mechanism uses the spring to maintain pressure on the pin 402 to maintain connection with the connector 408 when the connector 408 is in a position to lock the pin 402 in position. FIGS. 5E and 5F illustrate a state where, after the car horn 308 has been pulled into the state described in connection with FIGS. 5C and 5D, the car horn 308 is rotated about the pin 402. This puts the car horn 308 in a rotated position as described herein such that the first arm, with this rotated car horn 308, does not interfere with the closure of the other arm 310 when the two arms are folded into the closed position.

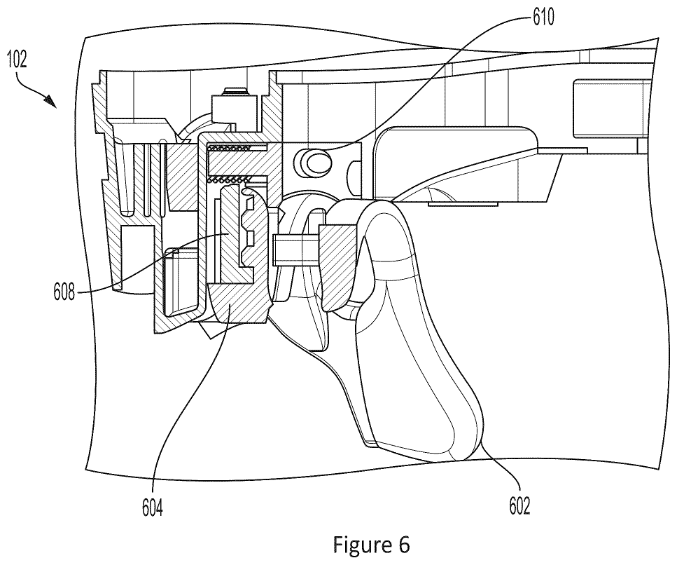

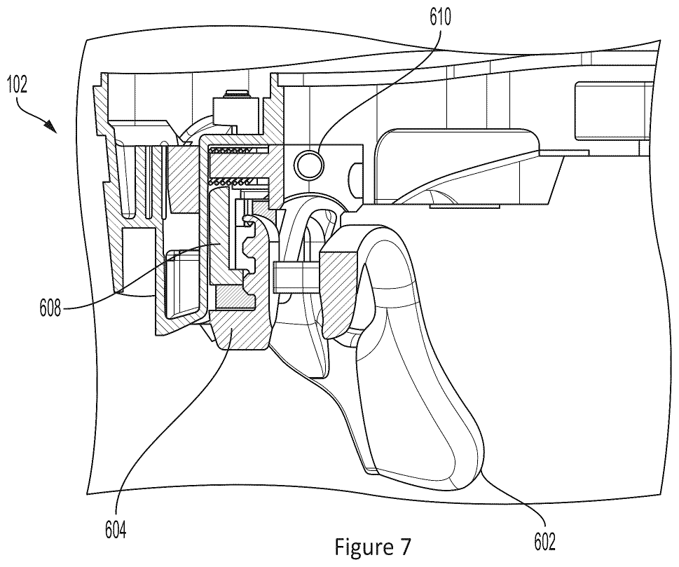

An aspect of the present invention relates to an adjustable nose bridge. An adjustable nose bridge may be important with head worn computers, especially those with computer displays, to ensure comfort and alignment of the displays and/or other portions of the head worn computer. FIG. 6 illustrates a HWC 102 with an adjustable nose bridge 602. The nose bridge is adjustable through a mechanism in the HWC 102. In embodiments, the mechanism includes a fixed notched attachment 604, a movable pin 608 adapted to fit into the notches of the notched attachment 604, and a selection device 610 that is attached to the movable pin 608. The movable pin 608 and nose bridge 602 are connected such that the as the movable pin 608 shifts in position the nose bridge 602 moves in position as well. The selection device 610 causes the movable pin 608 to engage and disengage with the fixed notched attachment 604 when presses and allowed to retract. As illustrated in FIG. 6, the selection device 610 is not in a pressed position so the movable pin 608 is engaged with the notched attachment 604 such that the nose bridge is securely attached in a stable position. FIG. 7 illustrates a scenario where the selection device is pressed, or activated, such that the moveable pin 608 is no longer engaged with the fixed notched attachment 604. This allows the nose bridge 602 to move up and down with respect to the rest of the HWC 102. Once the movable pin 608 aligns with a notch of the notched attachment 604, the two parts may engage to re-secure the nose bridge in the HWC 102.

In embodiments, a side arm of the HWC 102 may include an audio jack (not shown) and the audio jack may be magnetically attachable to the side arm. For example, the temple section 304 or ear horn section 308 may have a magnetically attachable audio jack with audio signal wires associated with an audio system in the HWC 102. The magnetic attachment may include one or more magnets on one end (e.g. on the head phone end or the side arm end) and magnetically conductive material on the other end. In other embodiments, both ends of the attachment may have magnets, of opposite polarization, to create a stronger magnetic bond for the headphone). In embodiments, the audio signal wires or magnetic connection may include a sensor circuit to detect when the headphone is detached from the HWC 102. This may be useful in situations where the wearer is wearing the headphones during a period when there is not constant audio processing (e.g. listening for people to talk with periods of silence). In embodiments, the other side's headphone may play a tone, sound, signal, etc. in the event a headphone is detached. In embodiments, an indication of the detachment may be displayed in the computer display.

In embodiments, the HWC 102 may have a vibration system that vibrates to alert the wearer of certain sensed conditions. In embodiments, the vibration system (e.g. an actuator that moves quickly to cause vibration in the HWC 102) may be mounted in a side arm (e.g. the temple section 304, or car horn 308), in the top mount 312, etc. In embodiments, the vibration system may be capable of causing different vibration modes that may be indicative of different conditions. For example, the vibration system may include a multi-mode vibration system, piezo-electric vibration system, variable motor, etc, that can be regulated through computer input and a processor in the HWC 102 may send control signals to the vibration system to generate an appropriate vibration mode. In embodiments, the HWC 102 may be associated with other devices (e.g. through Bluetooth, WiFi, etc.) and the vibratory control signals may be associated with sensors associated with the other device. For example, the HWC 102 may be connected to a car through Bluetooth such that sensor(s) in the car can cause activation of a vibration mode for the vibration system. The car, for example, may determine that a risk of accident is present (e.g. risk of the driver falling asleep, car going out of its lane, a car in front of the wearer is stopped or slowing, radar in the car indicates a risk, etc.) and the car's system may then send a command, via the Bluetooth connection, to the HWC 102 to cause a vibratory tone to be initiated in the HWC 102.

Although embodiments of HWC have been described in language specific to features, systems, computer processes and/or methods, the appended claims are not necessarily limited to the specific features, systems, computer processes and/or methods described. Rather, the specific features, systems, computer processes and/or and methods are disclosed as non-limited example implementations of HWC.

All documents referenced herein are hereby incorporated by reference.

1. A wearable head device, comprising:
a see-through display;
a frame configured to support the see-through display; and
a first side arm attached to the frame and configured to hold the wearable head device on the head of a user, the first side arm comprising:
a temple section comprising a coupling member and a compartment adapted to contain a battery, the battery configured to power the see-through display, and
an ear horn section configured to permit attachment to the temple section and comprising a pin, wherein the temple section comprises an opening and the pin is configured to fit inside the opening,
wherein the coupling member is configured to, in a first position, permit attachment of the ear horn section to the temple section and, in a second position, permit detachment of the ear horn section from the temple section.

2. The wearable head device of claim 1, wherein the see-through display comprises an organic light emitting diode (OLED) display.

3. The wearable head device of claim 1, wherein the see-through display comprises a liquid crystal on silicon (LCoS) display.

4. The wearable head device of claim 1, wherein the see-through display comprises a digital light processing (DLP) display.

5. The wearable head device of claim 1, further comprising an audio output jack, wherein the wearable head device is configured to present audio to the user via the audio output jack.

6. The wearable head device of claim 5, wherein the first side arm comprises the audio output jack.

7. The wearable head device of claim 1, wherein:
the pin is located at a first end of the ear horn section;
the opening is disposed at a first end of the temple section; and
the coupling member is configured to, in the first position, permit securing the pin inside the opening and, in the second position, permit removal of the pin from the opening.

8. The wearable head device of claim 1, further comprising a haptic actuator, wherein the wearable head device is configured to present a haptic signal to the user via the haptic actuator.

9. The wearable head device of claim 8, wherein the first side arm comprises the haptic actuator.

10. The wearable head device of claim 1, wherein the coupling member is configured to permit rotation of the ear horn section relative to the temple section.

11. The wearable head device of claim 1, wherein the see-through display comprises a light source and a display portion.

12. A method comprising:
generating, via a see-through display of a wearable head device, image light associated with virtual content; and
presenting the image light to a user of the wearable head device via the see-through display;
wherein:
the wearable head device comprises:
a frame configured to support the see-through display, and
a first side arm attached to the frame and configured to hold the wearable head device on the head of the user, the first side arm comprising:
a temple section comprising a coupling member and a compartment adapted to contain a battery, the battery configured to power the see-through display; and
an ear horn section configured to permit attachment to the temple section and comprising a pin, wherein the temple section comprises an opening and the pin is configured to fit inside the opening,
wherein the coupling member is configured to, in a first position, permit attachment of the ear horn section to the temple section and, in a second position, permit detachment of the ear horn section from the temple section.

13. The method of claim 12, wherein the see-through display comprises an organic light emitting diode (OLED) display.

14. The method of claim 12, wherein the see-through display comprises a liquid crystal on silicon (LCoS) display.

15. The method of claim 12, wherein the see-through display comprises a digital light processing (DLP) display.

16. The method of claim 12, wherein the wearable head device further comprises an audio output jack, and wherein the method further comprises presenting audio to the user via the audio output jack, concurrently with presenting the image light and a view of a surrounding environment via the see-through display.

17. The method of claim 16, wherein the first side arm comprises the audio output jack.

18. The method of claim 12, wherein:
the pin is located at a first end of the ear horn section;
the opening is disposed at a first end of the temple section; and
the coupling member is configured to, in the first position, permit securing the pin inside the opening and, in the second position, permit removal of the pin from the opening.

19. The method of claim 12, wherein the wearable head device further comprises a haptic actuator, and wherein the method further comprises presenting a haptic signal to the user via the haptic actuator concurrently with presenting the image light and a view of a surrounding environment via the see-through display.

20. The method of claim 19, wherein the first side arm comprises the haptic actuator.
